(19) United States
(12) Patent Application Publication
(10) Pub. No.: US 2002/0180229 A1
(43) Pub. Date: Dec. 5, 2002

(54) Custodial divider

(76) Inventor: Roger D. Wheat, Jefferson City, MO (US)

Correspondence Address: Mark Manley, Dockery Suite 102, Central Missouri State University, Warrensburg, MO, 64093, US

(21) Appl. No.: 10/159,847

(22) Filed: May 31, 2002

Related U.S. Application Data
(60) Provisional application No. 60/295,505, filed on Jun. 1, 2001.

(51) Int. Cl. B60P 3/05

(52) U.S. Cl. 296/24.1

(57) ABSTRACT

A custodial divider is used to divide the back seat of a vehicle into two or three separate areas such that a person on one side of the divider can not reach the person or material on the other side of the divider. A typical application of the divider would be for transporting potentially dangerous persons such as prisoners being moved from one prison to another in the back seat of a car. The existing cushion of the seat back bottom is used to hold the divider in place by forcing it against the roof of the vehicle.

### BACKGROUND OF THE INVENTION

1. Field of the Invention

The present invention relates to custodial dividers used to protect law enforcement professionals and others during the transportation of prisoners by automobile.

2. Description of the Prior Art

It is common to need to transfer potentially dangerous prisoners from one location to another. This may be needed in transferring a prisoner from a local holding cell to prison or from one type of prison to another or in transporting two people who have just been involved in a fight. It is well established that many dangerous situations, crimes and escapes occur during these attempts to transfer prisoners or any potentially dangerous person.

To improve safety in transferring prisoners it has become common practice to build a divider between the prisoners in the back of a vehicle and the guards in the front of the vehicle. In recent years these dividers are sometimes made of solid materials to prevent prisoners with dangerous diseases such as HIV, A, B and C Hepatitis as well as other diseases from potentially transferring those to guards. The divider between the front seat and the back seat is typically bolted in place and is not removed from the car during its service life.

It is common practice to seat belt prisoners in the transfer vehicle, to remove all inside door knobs and window cranks and to hand cuff and shackle prisoners. All these measures have increased safety for the guards, but with the growing costs of transferring prisoners and simple logistics it is often times necessary to transfer more than one prisoner in a vehicle at a time. In this situation a host of problems can arise because there is no safety shield between the prisoners. In cases where more then one prisoner is being transferred in the back seat of an automobile the ability of these prisoners to come in physical contact with each other greatly increases the risks to the prisoners and to the guards. A common situation where problems can arise is where two people have been in a fight and must be taken to jail in the same car. This is a very dangerous situation for the prisoners and for the guards.

### SUMMARY OF THE INVENTION

The present invention relates to transferring multiple prisoners in the back seat of a car. The device provides for increased safety for each prisoner by making it difficult for any prisoner to initiate physical contact with another prisoner. The device makes it safer to transfer prisoners with dangerous diseases. The device also provides increased safety for the guards by keeping each prisoner in their space, preventing the easy exchange of drugs, weapons or any other contraband and by slowing down a prisoner who becomes violent. The divider makes it possible to transfer prisoners of the opposite sex in the same back seat.

The custodial divider provides an easily removed partition that can be placed between two individuals who may not like each other but who must be transported in the back seat of the same car. It is even possible to use both sets of seat belts with two custodial dividers and transfer three prisoners in the back seat of a car. The divider can be removed and transported in the trunk of the vehicle when not needed or not in use. The custodial divider also provides a way to restrict the movement of a prisoner in the back seat of a car even when there is only one person in the back seat. Because it is easily removable the device can be removed for cleaning both of the device and of the back seat. The guards on duty can remove the device when it is not needed.

### BRIEF DESCRIPTION OF THE DRAWINGS

FIG. 1 shows a view of the divider in the back seat of a car.

FIG. 2 shows a view of the divider in place in a back seat

FIG. 3 shows a second embodiment of the divider in a car

### DESCRIPTION OF THE PREFERRED EMBODIMENTS

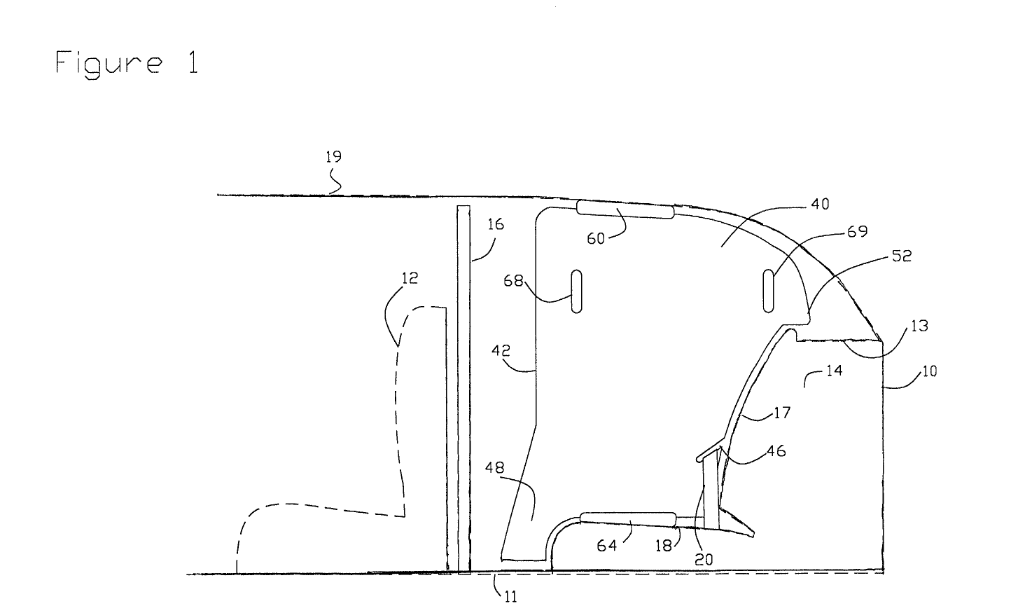

FIG. 1 shows a cut away view of a car (10) including a floor (11), front seat (12), a window ledge (13), back seat (14) prior art fixed front divider (16). The back seat includes a back portion (17) and a bottom portion (18). The car includes a roof (19). The back seat also has a typical lap seat belt (20).

The custodial divider (40) is a thin device. The custodial divider is sized to fit in the area defined by the back seat (14), the roof (19) and the fixed divider (16), which is typically bolted to the floor (11) and extends across the width of the vehicle to separate the guards in the front seat (12) from the back seat area. The edge (42) of the divider (40) is sculptured to fit several different cars commonly used to transport prisoners without leaving large gaps in critical areas that would defeat the purpose of dividing the passengers.

The Custodial divider (40) includes an opening (46) that allows the vehicle seat belt (20) to pass through. A foot section (48) of the divider (40) keeps the feet of prisoners separate, though it is not necessary for this section to extend clear to the floor (11). A head section (52) of the divider (40) extends over the top of the back portion (17) of the back seat (14). Upper (60) and lower (64) strips of material allow the divider (40) to be wedged in between the roof (19) and the lower portion of the back seat (18). Experimentation has shown that the divider is stable when placed in this manner into the car. The bottom portion of the back seat (18) of the automobile is typically spring loaded so that it has give when a person sits in it, this spring loading is used to assist in holding the device in a wedged position between the seat bottom (18) and the roof(19).

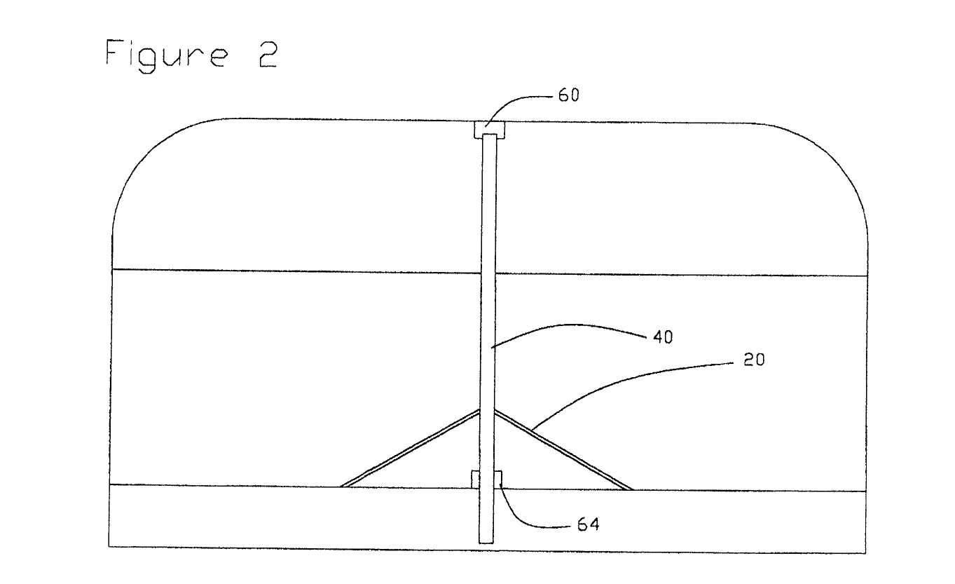

FIG. 2 shows an edge on view of the divider (40) from the front seat of the car. A key advantage of the divider is that it does not obscure the vision of the office in the front seat into the back seat.

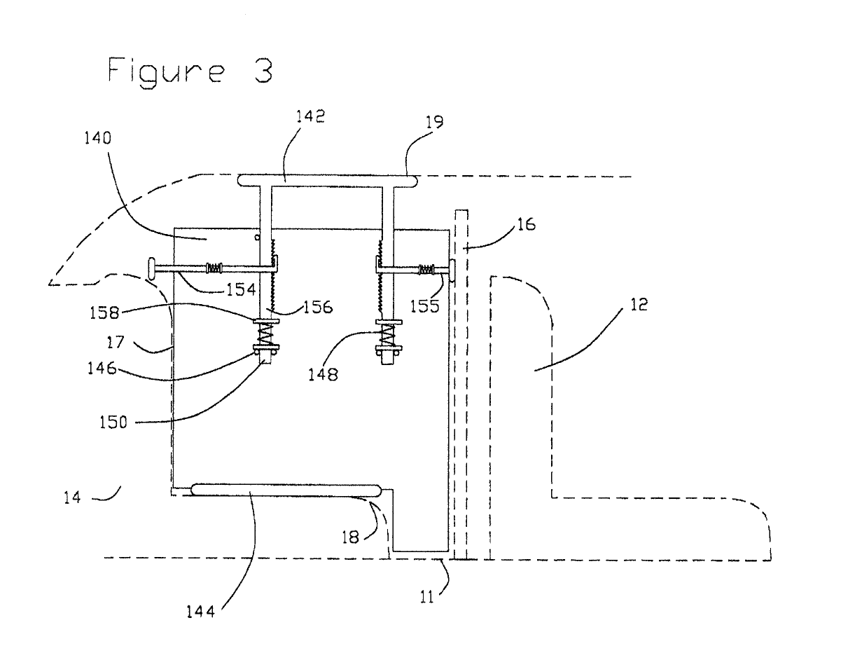

FIG. 3 shows an alternative embodiment of the custodial divider concept. The custodial divider (140) includes two bumpers, a top fixed bumper (142) and a lower movable bumper (144). Springs (148) push against pins (146) and against shoulders (158) on rods (150) to bias the movable bumper (142) against the roof (19). Release of the spring biased levers (154,155) which engage with teeth (156) allows the bumper (142) to move. This holds the barrier (140) in place. To remove the barrier the user simply holds in levers (154, 155) and presses the barrier (140) down against the springs (148) and pulls the entire barrier (140) from the car. This design would allow for some spring force from the divider to hold it in place. Current research indicates that the embodiment of FIG. 1 will work in most applications because the vehicle seat is sufficiently flexible to hold the divider tightly in place.

Referring again to FIG. 1, in operation the custodial divider (40) is placed in the back seat (14) dividing the back seat area into two halves. Installation may require that the bottom portion (18) of the back seat get compressed a little so that the resulting force holds the divider in place against the roof (19). As can be seen the top edge of the panel (40) conforms with the roof line (19) of the vehicle, the back edge of the panel (40) conforms with the back of the back seat back (17). The front edge of the panel (40) allows for a slight gap with a floor mounted rigid divider (16) and the bottom edge of the panel (40) conforms roughly with the bottom of the back seat (18). This allows the custodial divider to effectively separate two persons placed on either side of it in the back seat.

In use, belt (20) is fed through opening (46) and the lap belt (20) is synched down tight compressing the edge of the divider (40) against the bottom portion (18) and the back portion (17) of the back seat (14). Research has shown that the lap belt is not necessary in most applications thou it makes the device somewhat more stable. Without the lap belt (20) the bottom edge of the divider (40) is simply pressed down against the back seat bottom cushion (18) and aligned so that the top edge of the divider (40) will be forced into the roof(19). Once the custodial divider (40) is in place as shown in FIG. 1, prisoners can be placed in the car, one from each side. When hand cuffed, shackled and seat-belted in prisoners on either side of the divider (40) will not be able to touch each other or exchange anything from one side of the divider to the other. Typically the divider will be made of clear material such as Plexiglas so that prisoners can not use any portion of the divider as a shield to hid contraband or to cover activity. As mentioned and shown in FIG. 2 the vision of an officer in the front seat is not obscured by the device. The divider need not be rigidly attached to the back seat (14) or to the body of the car. The custodial divider will give and move if it is hit hard, but even if it tilts somewhat it will continue to maintain a shield between the two prisoners. The goal of the device is not to provide an unmovable shield. The device is designed to prevent casual contact, spitting or taunting contact between the prisoners and to give the officers time to respond to a violent outburst from one or both prisoners by limiting contact though the device itself may lean over out of its upright position. This will give guards in the front of the car enough time to respond to a violent outburst from one prisoner before the other can be injured. In addition to separating two prisoners the device could be used to separate for example one prisoner from equipment that must be transported or from a police dog. The device also has application for transporting people from a fight where the two people being transported might try to start fighting again. By using two dividers and both lap belts in the back seat it is possible to separate and transport three prisoners.

The custodial divider allows for the police sedan or transport vehicle to be used in a much more economical manner. It also allows for improved safety both for the guards and for the prisoners being transported.

What is claimed is:

1. A custodial divider for use in combination with an automobile having a rear passenger area defined by a roof, a front seat a back seat bottom and a back seat back;
A ridged panel having a top edge, a bottom edge, a front edge and a back edge
said back edge of said rigid panel conforming to and located adjacent to said back seat back and said ridged panel being sized such that said top edge conforms to and rests adjacent to said roof when said bottom edge is resting on said back seat bottom wherein said custodial divider divides said rear passenger area into two rear passenger areas and wherein said custodial divider is held in place by a compressive force applied by the back seat bottom through the divider and onto the roof of the vehicle.

2. In combination a custodial divider and an automobile having a rear passenger area defined by a roof, a front seat, a back seat bottom long enough to accommodate at least two passengers and a seat back;
a rigid panel having a top edge, a bottom edge, a front edge and a back edge,
said back edge of said rigid panel conforming to and located adjacent to said back seat back and said ridged panel being sized such that said top edge conforms to and rests adjacent to said roof when said bottom edge is resting on said back seat bottom wherein said custodial divider divides said rear passenger area into two rear passenger areas and wherein said custodial divider is held in place by a compressive force applied by the back seat bottom through the divider and onto the roof of the vehicle.

3. In combination a custodial divider and an automobile having a rear passenger area defined by a roof, a fixed divider adjacent a front seat, a back seat bottom long enough to accommodate at least two passengers and a seat back;
a rigid panel having a top edge, a bottom edge, a front edge and a back edge,
said back edge of said rigid panel conforming to and located adjacent to said back seat back and said ridged panel being sized such that said top edge conforms to and rests adjacent to said roof when said bottom edge is resting on said back seat bottom wherein said custodial divider divides said rear passenger area into two rear passenger areas and wherein said custodial divider is held in place by a compressive force applied by the back seat bottom through the divider and onto the roof of the automobile.

4. The combination custodial divider and automobile of claim 3 wherein said top edge includes a compressible pad resting against said roof.

5. The combination custodial divider and automobile of claim 3 wherein said bottom edge includes a compressible pad resting against said back seat bottom.

6. The combination custodial divider and automobile of claim 3 wherein said rigid panel includes a slot passing through it such that a seat belt adjacent to the back seat bottom can pass through the custodial divider to secure it to the automobile.

7. The combination custodial divider and automobile of claim 3 wherein said rigid panel is made from clear material.
